(19) United States
(12) Patent Application Publication
(10) Pub. No.: US 2019/0086677 A1
(43) Pub. Date: Mar. 21, 2019

(54) HEAD MOUNTED DISPLAY DEVICE AND CONTROL METHOD FOR HEAD MOUNTED DISPLAY DEVICE

(71) Applicant: SEIKO EPSON CORPORATION, Tokyo (JP)

(72) Inventor: Takashi TOMIZAWA, Chiisagata-Gun (JP)

(73) Assignee: SEIKO EPSON CORPORATION, Tokyo (JP)

(21) Appl. No.: 16/134,408

(22) Filed: Sep. 18, 2018

(30) Foreign Application Priority Data
Sep. 19, 2017 (JP) 2017-178631

(51) Int. Cl. G02B 27/01; G06T 19/00

(52) U.S. Cl. CPC G02B 27/0179; G06T 19/006; G02B 2027/0138; G02B 2027/0185; G02B 2027/0178; G02B 27/0172

(57) ABSTRACT

An HMD includes a control unit configured to control a display position of an image displayed on a display region, and a storage unit configured to store a display position table including: distance information indicating a visual recognition distance perceived by a user for the image displayed on the display region, and the display position of the image displayed on the display region or a movement amount of the display position associated with the distance information. The control unit selects the distance information based on an operation received by an operation unit, and controls the display position of the image displayed on the display region according to the display position of the image or the movement amount of the display position associated with the selected distance information by the display position table.

The present application is based on and claims priority from JP Application Serial Number 2017-178631, filed Sep. 19, 2017, the disclosure of which is hereby incorporated by reference herein in its entirety.

### BACKGROUND

### 1. Technical Field

The disclosure relates to a head mounted display device and a control method for the head mounted display device.

### 2. Related Art

Head mounted display devices that are mounted on the head of a user and display an image while enabling a real space to be visually recognized have been known (see, for example, JP-A-2016-9056). The user of the head mounted display device is capable of simultaneously visually recognizing both an object in the real space and the image displayed by the head mounted display device. This configuration might involve a large difference in a focal distance between the image displayed by the head mounted display device and the object in the real space, both of which are gazed by the user. Such a difference renders the image and the object impossible to be simultaneously visually recognized, or results in a double image imposing a large strain on the user's eyes.

The head mounted display device disclosed in JP-A-2016-9056 includes a distance acquiring unit that acquires a distance, a line of sight direction detecting unit that detects a line of sight direction of the user, an outside scene shooting unit that shoots an outside scene, and a support image display control unit that causes a support image to be displayed. The support image display control unit detects a person's face in the shot image obtained by the outside scene shooting unit, and selects a face in the line of sight direction of the user, detected by the line of sight direction detecting unit, as an object. The support image display control unit adjusts the focal distance of the support image to achieve a length corresponding to the distance acquired by the distance acquiring unit.

Unfortunately, a complex process might be required for the configuration of the head mounted display device disclosed in JP-A-2016-9056 where the target object is selected with the line of sight direction of the user detected. In view of this, there has been a demand for easily adjusting a display position of an image to be displayed.

### SUMMARY

An object of the disclosure is to reduce a strain on user's eyes with a simple configuration.

A head mounted display device includes a display unit that is mounted on a head of a user, configured to enable an outside scene to be visually recognized through the display unit, and displays an image on a display region overlapping with the outside scene, an input unit configured to receive an input, a control unit configured to control a display position of the image displayed on the display region, and a storage unit configured to store display position information including distance information indicating a visual recognition distance perceived by the user for the image displayed on the display region, and the display position of the image displayed on the display region or a movement amount of the display position associated with the distance information. The control unit selects the distance information based on the input received by the input unit, and controls the display position of the image displayed on the display region according to the display position of the image or the movement amount of the display position associated with the selected distance information by the display position information.

With this configuration, an image is displayed at a position corresponding to the selected distance information. Thus, an image is displayed with a small difference in the focal distance with respect to an object in the neighborhood of a point corresponding to the distance indicated by the selected distance information, whereby a strain on the user's eyes is reduced.

When the distance information is designated by the input received by the input unit, the control unit may control the display position of the image displayed on the display region according to the display position of the image or the movement amount of the display position associated with the designated distance information by the display position information.

With this configuration, an image is displayed at a position corresponding to the designated distance information. Thus, an image is displayed with a small difference in the focal distance with respect to an object in the neighborhood of a point corresponding to the distance indicated by the selected distance information, whereby a strain on the user's eyes is reduced.

The storage unit may store use information related to a use situation of the head mounted display device in association with the distance information, and when the use information is designated by the input received by the input unit, the control unit may identify the distance information corresponding to the designated use information, and control the display position of the image displayed on the display region according to the display position of the image or the movement amount of the display position associated with the identified distance information by the display position information.

With this configuration, an image is displayed at a position corresponding to the designated use situation. Thus, the image is displayed with a small difference in the focal distance with respect to an object in the neighborhood of a position corresponding to the designated use situation, whereby a strain on the user's eyes is reduced.

The storage unit may store use information related to a use situation of the head mounted display device in association with the distance information, and the control unit may determine the use situation of the head mounted display device, identify the distance information stored in the storage unit in association with the use information corresponding to the determined use situation, and control the display position of the image displayed on the display region according to the display position of the image or the movement amount of the display position associated with the identified distance information by the display position information.

With this configuration, the use situation of the user is identified, and an image is displayed at a display position corresponding to the identified use situation. Thus, the image is displayed with a small difference in the focal distance with respect to an object in the neighborhood of a position corresponding to the use situation, whereby a strain on the user's eyes is reduced.

The distance information may be constructed by a natural language that stepwisely indicates the visual recognition distance.

With this configuration, the visual recognition distance is easily selected, and the display position of the image displayed on the display region is easily adjusted.

The distance information may indicate the visual recognition distance perceived by the user, by using at least one of words including close, normal, and far.

With this configuration, the visual recognition distance is easily selected, and the display position of the image displayed on the display region is easily adjusted.

The control unit may control the display position of the image displayed on the display region based on the distance information designated by the input received by the input unit, in a state where the distance information in the display position information is displayed by the display unit.

With this configuration, the distance information is displayed, therefore, appropriate distance information is selected when a difference in the focal distance with respect to the displayed image is large.

The display unit may include a left display region corresponding to a left eye of the user and a right display region corresponding to a right eye of the user, and display an image on each of the left display region and the right display region, and the control unit may respectively control a display position of the image displayed on the left display region and a display position of the image displayed on the right display region.

With this configuration, an optimum adjustment to the display position of the image displayed by the display unit is implemented.

A head mounted display device includes a display unit that is mounted on a head of a user, configured to enable an outside scene to be visually recognized through the display unit, and displays an image on a display region overlapping with the outside scene, a detecting unit configured to detect a marker at least in a range visually recognized through the display unit, and a control unit configured to control a display position of an image displayed on the display region. The control unit may control the display position of the image displayed on the display region based on a detection position of the marker detected by the detecting unit.

With this configuration, the display position of the image is appropriately controlled based on the detection position of the marker. Thus, the image is displayed with a small difference in the focal distance with respect to an object in the neighborhood of a position corresponding to the distance corresponding to the position of the detected marker, whereby a strain on the user's eyes is reduced.

The head mounted display device may further include a storage unit configured to store display control information in which the detection position of the marker detected by the detecting unit is correlated with a display position of the image displayed on the display region or a movement amount of the display position. The control unit may control the display position of the image displayed on the display region by obtaining the display position of the image displayed on the display region or the movement amount of the display position with use of the display control information stored in the storage unit based on the detection position of the marker detected by the detecting unit.

With this configuration, the display position of the image is appropriately controlled based on the detection position of the marker.

The head mounted display device may further include an input unit that receives an input. The control unit may generate the display control information in which the detection position of the marker detected by the detecting unit is associated with the display position of the image determined based on the input received by the input unit and store the display control information in the storage unit.

With this configuration, the display control information, in which the detection position of the marker and the display position of the image are associated with each other, is generated with a simple configuration. The display position of the image is set based on a sense of distance of the user.

The control unit may change the display position of the image displayed on the display region with a plurality of steps to achieve different visual recognition distances perceived by the user for the image displayed on the display region. The control unit may generate the display control information in which the display position selected based on the input received by the input unit is associated with the detection position of the marker detected by the detecting unit, and store the display control information in the storage unit.

With this configuration, the image is displayed at positions with different visual recognition distances perceived by the user, based on the detection position of the marker.

Provided is a control method for a head mounted display device including a display unit that is mounted on a head of a user, configured to enable an outside scene to be visually recognized through the display unit, and displays an image on a display region overlapping with the outside scene. The control method includes storing in advance display position information including distance information indicating a visual recognition distance perceived by the user for the image displayed on the display region, and a display position of the image displayed on the display region or a movement amount of the display position associated with the distance information, receiving an input by an input unit, and controlling, when the distance information is designated by the input received by the input unit, the display position of the image displayed on the display region according to the display position of the image or the movement amount of the display position associated with the designated distance information by the display position information.

With this configuration, an image is displayed at a position corresponding to the selected distance information. Thus, an image is displayed with a small difference in the focal distance with respect to an object in the neighborhood of a point corresponding to the distance indicated by the selected distance information, whereby a strain on the user's eyes is reduced.

Provided is a control method for a head mounted display device including a display unit that is mounted on a head of a user, configured to enable an outside scene to be visually recognized through the display unit, and display an image on a display region overlapping with the outside scene. The control method may include detecting a marker at least in a range visually recognized through the display unit, and controlling a display position of the image displayed on the display region based on a detection position of the detected marker.

With this configuration, the display position of the image is appropriately controlled based on the detection position of the marker. Thus, the image is displayed with a small difference in the focal distance with respect to an object in the neighborhood of a position corresponding to the distance corresponding to the position of the detected marker, whereby a strain on the user's eyes is reduced.

### BRIEF DESCRIPTION OF THE DRAWINGS

Embodiments of the disclosure will be described with reference to the accompanying drawings, wherein like numbers reference like elements.

FIG. 1 is an outer view of an HMD.

FIG. 2 is a plan view of main part illustrating a configuration of an optical system of the HMD.

FIG. 3 is a perspective view illustrating a configuration of an image display unit.

FIG. 4 is a block diagram of the HMD.

FIG. 5 is a functional block diagram of a control device.

FIG. 6 is a diagram illustrating a display position table.

FIG. 7 is a diagram illustrating a display position table.

FIG. 8 is a diagram illustrating relationship between a size of a reference region and a size of an emission region.

FIG. 9 is a diagram illustrating an image formed based on image light emitted from a display unit.

FIG. 10 is a diagram illustrating a visual field range and a display region.

FIG. 11 is a flowchart illustrating processing executed by a control unit.

FIG. 12 is a flowchart illustrating processing executed by a control unit.

FIG. 13 is a flowchart illustrating processing executed by a control unit.

### DESCRIPTION OF EXEMPLARY EMBODIMENTS

### First Exemplary Embodiment

A first exemplary embodiment of the disclosure is described below with reference to the accompanying drawings.

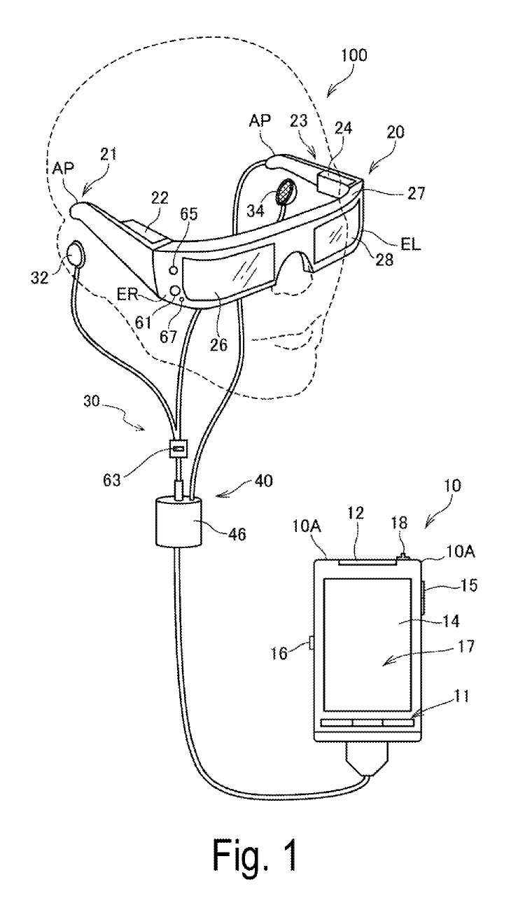

FIG. 1 is a diagram illustrating an external configuration of a Head Mounted Display (HMD) serving as a head mounted display device employing the disclosure. The HMD 100 is a display device including a control device 10 and an image display unit 20. The image display unit 20 corresponds to a “display unit” according to the disclosure.

The control device 10 includes an operation unit that receives an operation of a user, and functions as a controller used by the user to operate the HMD 100. The control device 10 receives the operation of the user, and controls the image display unit 20 in response to the received operation. The image display unit 20 is mounted on the head of the user, and makes the user visually recognize a virtual image. The user is a person who is wearing the image display unit 20 on his or her head.

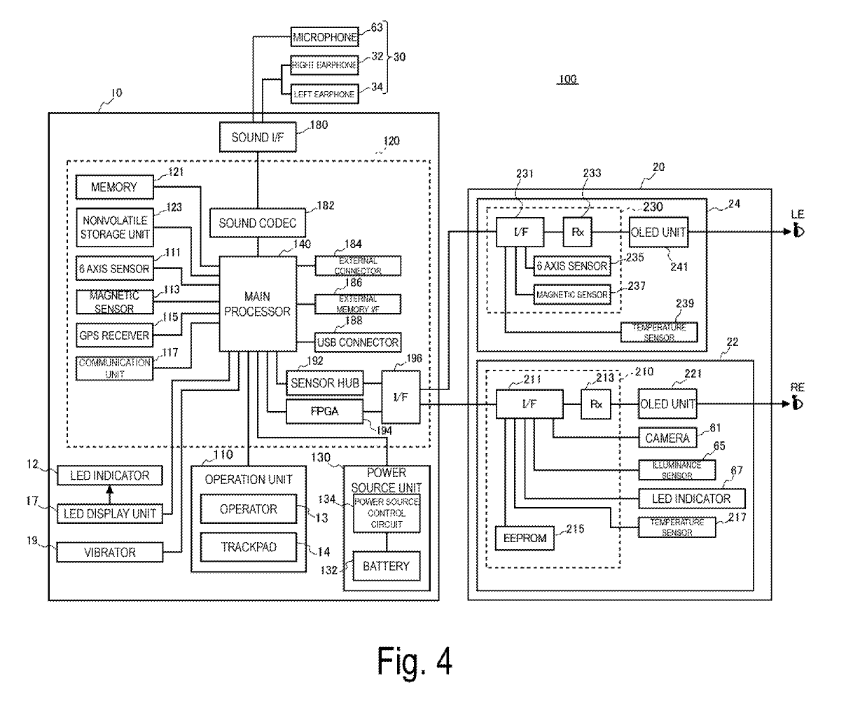

The control device 10 has a flat box shaped casing 10A (also referred to as a housing or a main body) as illustrated in FIG. 1. The casing 10A includes various components such as operation buttons 11, a light emitting diode (LED) indicator 12, a trackpad 14, up and down keys 15, a changeover switch 16, and a power switch 18. The operation buttons 11, the up and down keys 15, the changeover switch 16, and the power switch 18 are collectively referred to as an operator 13 (FIG. 4). The user can operate the operator 13 and the trackpad 14 to operate the HMD 100.

The operation buttons 11 include a menu key, a home key, a return key, and the like, more specifically, of these types of keys and switches, includes those that is displaced due to a pressing operation. The LED indicator 12 turns ON and blinks in accordance with the operation status of the HMD 100.

The trackpad 14 includes an operation surface on which a contact operation is detected, and outputs an operation signal in responses to the operation with respect to the operation surface. The operation on the operation surface of the trackpad 14 can be detected with various schemes including an electrostatic scheme, a pressure detection scheme, and an optical scheme.

The up and down keys 15 are used for inputting an instruction to raise or lower the volume of sound output from right and left earphones 32 and 34, or inputting an instruction to increase or decrease the brightness of the display on the image display unit 20. The changeover switch 16 is a switch for changing input corresponding to the operation to the up and down keys 15. The power switch 18 is a switch for turning ON and OFF the HMD 100, and includes a slide switch for example.

The image display unit 20 is a mounted member that is mounted on the head of the user, and has an eyewear shape in the first exemplary embodiment. The image display unit 20 has a main body including a right holding unit 21, a left holding unit 23, and a front frame 27. The main body is provided with a right display unit 22, a left display unit 24, a right light-guiding plate 26, and a left light-guiding plate 28.

The right holding unit 21 and the left holding unit 23 respectively extend rearward from both end portions of the front frame 27, and serve as temples of the eyewear to hold the image display unit 20 on the head of the user. Both end portions of the front frame 27 include, in a state where the image display unit 20 is worn, an end portion positioned on the right side of the user which is referred to as an end portion ER, and an end portion positioned on the left side of the user which is referred to as an end portion EL. The right holding unit 21 extends from the end portion ER of the front frame 27 to a position corresponding to the right side of the head of the user in the state where the image display unit 20 is worn. The left holding unit 23 extends from the end portion EL of the front frame 27 to a position corresponding to the left side of the head of the user in the state where the image display unit 20 is worn.

The right light-guiding plate 26 and the left light-guiding plate 28 are provided to the front frame 27. In the state where the image display unit 20 is worn, the right light-guiding plate 26 is positioned in front of the right eye of the user to enable an image to be visually recognized with the right eye. In the state where the image display unit 20 is worn, the left light-guiding plate 28 is positioned in front of the left eye of the user to enable an image to be visually recognized with the left eye.

The front frame 27 has a shape connecting one end of the right light-guiding plate 26 and one end of the left light-guiding plate 28 with each other. This connecting position corresponds to the user's glabella in the state where the image display unit 20 is worn by the user. The front frame 27 may be provided with a nose pad portion abutting on the nose of the user in the state where the image display unit 20 is worn, at a connection position of the right light-guiding plate 26 and the left light-guiding plate 28. In this case, the image display unit 20 is held on the head of the user by the nose pad portion and the right and the left holding units 21 and 23. A belt (not illustrated) that is in contact with the back of the head of the user in the state where the image display unit 20 is worn may be connected to the right holding unit 21 and the left holding unit 23. In this case, the image display unit 20 is held on the head of the user by the belt.

The right display unit 22 displays an image with the right light-guiding plate 26. The right display unit 22 is provided to the right holding unit 21 and is disposed in the neighborhood of the right side of the head of the user in the worn state. The left display unit 24 displays an image with the left light-guiding plate 28. The left display unit 24 is provided to the left holding unit 23 and is disposed in the neighborhood of the left side of the head of the user in the worn state.

The right light-guiding plate 26 and the left light-guiding plate 28 are optical members made of light transmissive resin and the like, and are formed of a prism for example. The right light-guiding plate 26 and the left light-guiding plate 28 guide image light, output from the right display unit 22 and the left display unit 24, to the eyes of the user.

The right light-guiding plate 26 and the left light-guiding plate 28 may be provided with a light control plate (not illustrated) on the surfaces of the right light-guiding plate 26 and the left light-guiding plate 28. The light control plate is a thin-plate shaped optical element having transmittance varying based on a wavelength band of the light, and functions as a so-called wavelength filter. For example, the light control plate is disposed to cover the front side of the front frame 27, opposite to the side of the eyes of the user. Transmittance of light with any wavelength band, such as visible light, infrared light, and ultraviolet light, is capable of being adjusted by selecting the optical characteristics of the light control plate appropriately. Thus, the amount of external light incident on the right light-guiding plate 26 and the left light-guiding plate 28 from outside and transmitting through the right light-guiding plate 26 and the left light-guiding plate 28 is capable of being adjusted.

The image display unit 20 is a see-through type display device that allows transmission of the external light so that the outside scene is visually recognized. The image display unit 20 respectively guides image light, generated by the right display unit 22 and the left display unit 24, to the right light-guiding plate 26 and the left light-guiding plate 28. The image light guided to the right light-guiding plate 26 and the left light-guiding plate 28 is made incident on the right eye and the left eye of the user, so that the user visually recognizes a virtual image. In this manner, the image display unit 20 displays an image. A region where the image display unit 20 is capable of displaying an image in a visual field range FV of the user wearing the image display unit 20 on his or her head is referred to as a display region VR.

In a case that the external light from the front side of the user transmit through the right light-guiding plate 26 and the left light-guiding plate 28 to be incident on the eyes of the user, the image light for forming the virtual image and external light are incident on the eyes of the user, and thus the visibility of the virtual image is influenced by the intensity of the external light. Thus, for example, the visibility of the virtual image is capable of being adjusted by disposing the light control plate on the front frame 27 and appropriately selecting or adjusting the optical characteristics of the light control plate. In a typical example, the light control plate may have light transmittance sufficient for enabling the user, wearing the HMD 100, to visually recognize the outside scene. The light control plate achieves effects such as protecting the right light-guiding plate 26 and the left light-guiding plate 28 and preventing damage, stain, or the like on the right light-guiding plate 26 and the left light-guiding plate 28. The light control plate may be configured to be detachably attached to the front frame 27 or each of the right light-guiding plate 26 and the left light-guiding plate 28. Thus, a plurality of types of light control plates may be attachable in an exchangeable manner. Furthermore, the image display unit 20 may have a configuration without the light control plate.

The front frame 27 of the image display unit 20 is provided with a camera 61. The camera 61 is configured and arranged to capture an image of an outside scene to be visually recognized by the user wearing the image display unit 20. The outside scene is a scene of the outside in the line of sight direction of the user wearing the image display unit 20 on his or her head. For example, the camera 61 is positioned on the front surface of the front frame 27 so as not to block the external light transmitting through the right light-guiding plate 26 and the left light-guiding plate 28. In the example illustrated in FIG. 1, the camera 61 is disposed on a side closer to the end portion ER of the front frame 27. The camera 61 corresponds to an “input unit” according to the disclosure.

The camera 61 is a digital camera including an image sensor such as a charged coupled device (CCD) or a complementary metal oxide semiconductor (CMOS), an imaging lens, and the like. The camera 61 which is a monocular camera in the first exemplary embodiment may also be a stereo camera. The camera 61 captures an image of at least a part of the outside scene in a front side direction of the HMD 100, that is, a field of vision direction of the user wearing the HMD 100. In other words, the camera 61 captures an image in a range or a direction overlapping with the field of vision of the user, and captures an image in a gazing direction of the user. The direction and the range of the angle of view of the camera 61 can be set as appropriate. In the first exemplary embodiment, as described below, the angle of view of the camera 61 includes the outside scene visually recognized by the user through the right light-guiding plate 26 and the left light-guiding plate 28. The angle of view of the camera 61 may be set to be capable of capturing an image covering the entire field of vision visually recognizable by the user through the right light-guiding plate 26 and the left light-guiding plate 28.

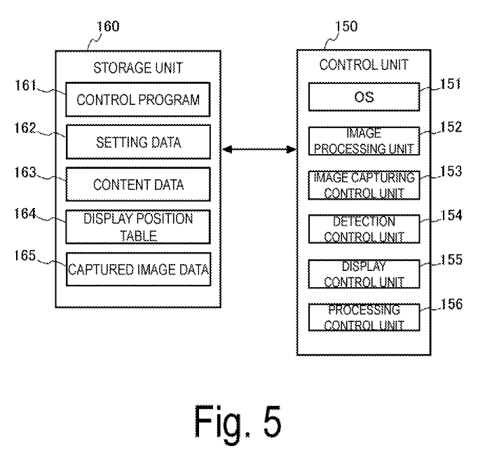

The camera 61 captures an image according to control performed by an image capturing control unit 153 (FIG. 5) of a control unit 150.

When the power switch 18 is turned ON, a main processor 140 starts by receiving power supply from a power source unit 130, and causes the power source unit 130 to start supplying power to the camera 61, so that the camera 61 turns ON.

The HMD 100 may include a distance sensor (not illustrated) that detects a distance to a measurement target positioned along a measurement direction set in advance. For example, the distance sensor may be disposed in the connection portion of the right light-guiding plate 26 and the left light-guiding plate 28 in the front frame 27. In this case, in the state where the image display unit 20 is worn, the distance sensor is positioned substantially in the middle of both eyes of the user in a horizontal direction and is positioned above both eyes of the user in a vertical direction. For example, the measurement direction of the distance sensor may be the front side direction of the front frame 27, that is, a direction overlapping with the image capturing direction of the camera 61. For example, the distance sensor may have a configuration including: a light source such as a light emitting diode (LED), a laser diode and the like; and a light receiving unit that receives reflected light as a result of reflection of light, emitted from the light source, on the measurement target. The distance sensor may perform a measurement process based on triangulation or time difference, according to control performed by the control unit 150. The distance sensor may have a configuration including: a sound source that emits ultrasonic waves; and a detecting unit that receives the ultrasonic waves reflected by the measurement target. In this case, the distance sensor performs the measurement process based on the time difference with respect to the reflection of the ultrasonic waves, according to control performed by the control unit 150.

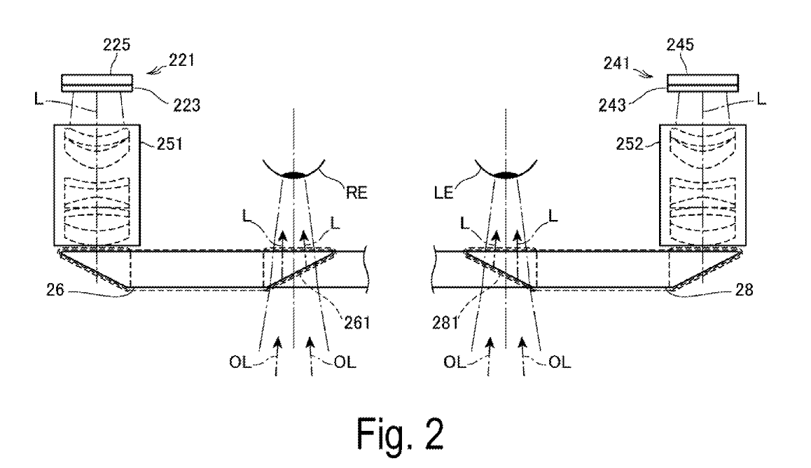

FIG. 2 is a plan view of a main part illustrating a configuration of an optical system of the image display unit 20. In FIG. 2, a left eye LE and a right eye RE of the user are illustrated for the sake of description.

As illustrated in FIG. 2, the right display unit 22 and the left display unit 24 are symmetrically configured. The right display unit 22 has a configuration, for making an image to be visually recognized with the right eye RE of the user, including: an Organic Light Emitting Diode (OLED) unit 221 that emits image light; and a right optical system 251 including a lens group that guides image light L emitted from the OLED unit 221. The right optical system 251 guides the image light L to the right light-guiding plate 26.

The OLED unit 221 includes an OLED panel 223 and an OLED driving circuit 225 that drives the OLED panel 223. The OLED panel 223 is a self-emitting display panel including light emitting elements arranged in a matrix. The light emitting elements respectively emit light of a corresponding one of colors red (R), green (G), and blue (B) by means of organic electroluminescence. The OLED panel 223 includes a plurality of pixels, each being a unit including one element for each of R, G, and B, and forms an image with the pixels arranged in a matrix. The OLED driving circuit 225 selects and energizes a light emitting unit in the OLED panel 223 so that the light emitting unit of the OLED panel 223 emits light, according to control performed by the control unit 150 (FIG. 5). The OLED driving circuit 225 is fixed to a back surface of the OLED panel 223, that is, a surface on the opposite side of a light emitting surface, by boding or the like. For example, the OLED driving circuit 225 includes a semiconductor device that drives the OLED panel 223, and may be mounted on a substrate (not illustrated) fixed on the back surface of the OLED panel 223. A temperature sensor 217 is mounted on this substrate.

The OLED panel 223 may have a configuration where light emitting elements that emit white light are arranged in a matrix, and color filters corresponding to the colors R, G, and B are laid over the light emitting elements. Furthermore, the OLED panel 223 may have a WRGB configuration including a light emitting element emitting white (W) light in addition to the light emitting elements respectively emitting light of corresponding one of colors R, G, and B.

The right optical system 251 includes a collimate lens that causes the image light L emitted from the OLED panel 223 to be parallel light beams. The image light L, caused to be the parallel light beams by the collimate lens, is incident on the right light-guiding plate 26. A plurality of reflection surfaces that reflect the image light L are formed in an optical path that guides light in the right light-guiding plate 26. The image light L is reflected in the right light-guiding plate 26 for a plurality of times to be guided toward the right eye RE. The right light-guiding plate 26 has a half mirror 261 (reflection surface) positioned in front of the right eye RE. The image light L is reflected by the half mirror 261 and is emitted toward the right eye RE from the right light-guiding plate 26, to be a focused image on the retina of the right eye RE, so that the image is visually recognized by the user.

The left display unit 24 has a configuration, for making an image visually recognized with the left eye LE of the user, including: an OLED unit 241 that emits image light; and a left optical system 252 including a lens group that guides the image light L emitted by the OLED unit 241. The left optical system 252 guides the image light L to the left light-guiding plate 28.

The OLED unit 241 includes an OLED panel 243 and an OLED driving circuit 245 that drives the OLED panel 243. The OLED panel 243 is a self-emitting display panel having a configuration similar to that of the OLED panel 223. The OLED driving circuit 245 selects and energizes a light emitting unit in the OLED panel 243 so that the light emitting unit of the OLED panel 243 emits light, according to control performed by the control unit 150 (FIG. 5). The OLED driving circuit 245 is fixed to a back surface of the OLED panel 243, that is, a surface on the opposite side of a light emitting surface, by boding or the like. For example, the OLED driving circuit 245 includes a semiconductor device that drives the OLED panel 243, and may be mounted on a substrate (not illustrated) fixed on the back surface of the OLED panel 243. A temperature sensor 239 is mounted on this substrate.

The left optical system 252 includes a collimate lens that causes the image light L emitted from the OLED panel 243 to be parallel light beams. The image light L, caused to be the parallel light beams by the collimate lens, is incident on the left light-guiding plate 28. A plurality of reflection surfaces that reflect the image light L are formed in an optical path that guides light in the left light-guiding plate 28 that is a prism for example. The image light L is reflected in the left light-guiding plate 28 for a plurality of times to be guided toward the left eye LE. The left light-guiding plate 28 has a half mirror 281 (reflection surface) positioned in front of the left eye LE. The image light L is reflected by the half mirror 281 and is emitted toward the left eye LE from the left light-guiding plate 28, to be a focused image on the retina of the left eye LE, so that the image is visually recognized by the user.

The HMD 100 having this configuration functions as a see-through display device. Specifically, the image light L reflected by the half mirror 261 and external light OL transmitted through the right light-guiding plate 26 are incident on the right eye RE of the user. The image light L reflected by the half mirror 281 and the external light OL transmitted through the half mirror 281 are incident on the left eye LE. Thus, with the HMD 100, the image light L of an internally processed image and the external light OL are incident on the eye of the user in an overlapping manner. The user can see the outside scene through the right light-guiding plate 26 and the left light-guiding plate 28, and is capable of visually recognizing an image, obtained from the image light L, overlappingly with the outside scene or in the periphery of the outside scene. The half mirrors 261 and 281 serve as image acquiring units that reflect the image light respectively output from the right display unit 22 and the left display unit 24 to acquire an image.

The left optical system 252 and the left light-guiding plate 28 are also collectively referred to as a “left light-guiding unit”, and the right optical system 251 and the right light-guiding plate 26 are collectively referred to as a “right light-guiding unit”. The configurations of the right light-guiding unit and the left light-guiding unit are not limited to the example described above, and may be any configuration as long as a virtual image is formed in front of the eyes of the user by using the image light. For example, a diffraction grating may be employed, or a semitransparent reflection film may be employed.

Referring back to FIG. 1, the control unit 10 and the image display unit 20 are connected to each other via a connection cable 40. The connection cable 40 is detachably connected to a connector (not illustrated) provided in a lower portion of the casing 10A, and establishes connection between a distal end of the left holding unit 23 and various circuits disposed in the image display unit 20. The connection cable 40 may include a metal cable or an optical fiber cable for transmitting digital data and may include a metal cable for transmitting an analog signal. A connector 46 is provided at an intermediate portion of the connection cable 40. The connector 46 is a jack for connecting a stereo mini plug, and is connected to the control device 10 through a line for transmitting an analog sound signal for example. In the configuration example illustrated in FIG. 1, the connector 46 is connected with a headset 30 including a right earphone 32, a left earphone 34, and a microphone 63.

The control device 10 and the image display unit 20 may be in wireless connection. For example, the control device 10 and the image display unit 20 may transmit and receive a control signal and data to and from each other, with wireless communications supporting standards such as Bluetooth (trade name) or a wireless local area network (WLAN including Wi-Fi (trade name)).

For example, as illustrated in FIG. 1, the microphone 63 has a sound collecting section arranged in the line of sight direction of the user, collects sound, and outputs a sound signal to a sound interface (I/f) 180 (FIG. 4). For example, the microphone 63 may be a monaural microphone, a stereo microphone, a directional microphone, or an omni-directional microphone.

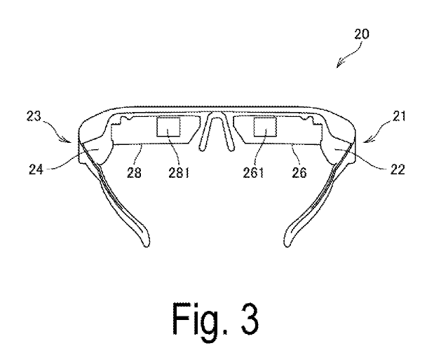

FIG. 3 is a perspective view illustrating a configuration of the image display unit 20, and illustrates a configuration of main parts of the image display unit 20 as viewed from the side of the head of the user. FIG. 3 illustrates the image display unit 20 as viewed from a side in contact with the head of the user, that is, a side as viewed from the right eye RE and the left eye LE of the user. In other words, the back sides of the right light-guiding plate 26 and the left light-guiding plate 28 are illustrated.

In FIG. 3, the half mirror 261 and the half mirror 281 with which the right eye RE and the left eye LE of the user are respectively irradiated with the image light are each illustrated as a substantially rectangular region. The right light-guiding plate 26 and the left light-guiding plate 28, respectively including the half mirrors 261 and 281, entirely transmit the external light as described above. Thus, the user visually recognizes the outside scene through the entire right and the left light-guiding plates 26 and 28, and visually recognizes a rectangular displayed image at positions of the half mirrors 261 and 281.

The camera 61 is disposed at a right-side end portion of the image display unit 20, and captures an image in a direction of both eyes of the user, that is, an image on the front side of the user. The camera 61 has an optical axis in a direction including the line of sight directions of the right eye RE and the left eye LE. The outside scene visually recognizable by the user wearing the HMD 100 is not necessarily at the infinite distance. For example, in a case that the user gazes at a target in front of him or her with both eyes, the distance between the user and the target is likely to be from approximately 30 cm to 10 m and is more likely to be from 1 m to 4 m. Thus, a reference may be set for the upper and the lower limits of the distance between the user and the target in a normal use state of the HMD 100. The reference may be determined through investigations and experiments, and may be set by the user. The optical axis and the angle of view of the camera 61 may be set in such a manner that a target with a distance corresponding to the reference for the upper or the lower limit in the normal use state is included in the angle of view.

Generally, a view angle of a person is approximately 200 degrees in the horizontal direction and is approximately 125 degrees in the vertical direction. The view angle includes an effective visual field superior in information receiving performance that is approximately 30 degrees in the horizontal direction and approximately 20 degrees in the vertical direction. Further, the stable field of fixation in which the gaze point gazed by a person can promptly and stably be viewed is roughly in the range from 60 to 90 degrees in the horizontal direction, and in the range from 45 to 70 degrees in the vertical direction. In a case where the gaze point is at the target positioned in front of the user, a range of approximately 30 degrees in the horizontal direction and approximately 20 degrees in the vertical direction centered on the lines of sight of the right eye RE and the left eye LE corresponds to the effective visual field. Further, a range from 60 to 90 degrees in the horizontal direction and from 45 to 70 degrees in the vertical direction corresponds to the stable field of fixation, and a range of approximately 200 degrees in the horizontal direction and approximately 125 degrees in the vertical direction corresponds to the view angle. The actual visual field visually recognized by the user through the right light-guiding plate 26 and the left light-guiding plate 28 may also be referred to as a field of view (FOV). With the configuration according to the first exemplary embodiment illustrated in FIG. 1 and FIG. 2, the field of view corresponds to an actual visual field visually recognized by the user through the right light-guiding plate 26 and the left light-guiding plate 28. The field of view is narrower than the view angle and the stable field of fixation, but is broader than the effective visual field.

The camera 61 captures an image within a range including the outside scene that is visually recognizable together with an image displayed by the image display unit 20. The camera 61 is capable of capturing an image in a range broader than the visual field of the user. Specifically, the angle of view may be larger than at least the effective visual field of the user. The angle of view may be larger than the field of view of the user. The angle of view may be larger than the stable field of fixation of the user. The angle of view may be larger than the view angle of both eyes of the user.

The camera 61 may include what is known as a wide-angle lens as an imaging lens, to be configured to be capable of capturing an image with a wide angle of view. The wide-angle lens includes lenses known as a super wide-angle lens and a semi wide-angle lens and may be a single focus lens or a zoom lens. Furthermore, the camera 61 may include a lens group including a plurality of lenses.

FIG. 4 is a block diagram illustrating a configuration of components of the HMD 100.

The control device 10 includes the main processor 140 that executes a program and controls the HMD 100. The main processor 140 is connected to a memory 121 and a nonvolatile storage unit 123. The main processor 140 is connected to sensors including a 6-axis sensor 11 and a magnetic sensor 113. The main processor 140 is further connected to a Global Positioning System (GPS) receiver 115, a communication unit 117, a sound codec 182, an external connector 184, an external memory I/F 186, a universal serial bus (USB) connector 188, a sensor hub 192, and a field programmable gate array (FPGA) 194. These components function as an I/F to the outside. The main processor 140 is connected with the LED indicator 12, an LED display unit 17, a vibrator 19, an operation unit 110, and the power source unit 130. The operation unit 110 corresponds to the “input unit” of the disclosure.

The main processor 140 is mounted on a controller substrate 120 incorporated in the control device 10. The memory 121, the nonvolatile storage unit 123, the 6-axis sensor 111, the magnetic sensor 113, the GPS receiver 115, the communication unit 117, the sound codec 182, and the like are also mounted on the controller substrate 120 in addition to the main processor 140. In the first exemplary embodiment, the external connector 184, the external memory I/F 186, the USB connector 188, the sensor hub 192, the FPGA 194, and an I/F 196 are mounted on the controller substrate 120.

The memory 121 serves as a work area where a control program and data to be processed are temporarily stored, when the main processor 140 executes the control program. The nonvolatile storage unit 123 includes a flash memory and an embedded Multi Media Card (eMMC). The nonvolatile storage unit 123 stores a program executed by the main processor 140 and various types of data processed by main processor 140 executing the program.

FIG. 4 illustrates a configuration where a single main processor 140 implements the functions of the control device 10. Alternatively, the functions of the control device 10 may be implemented by a plurality of processors or semiconductor chips. For example, co-processors such as a System-on-a-Chip (SoC), a Micro Control Unit (MCU), a FPGA, and the like may be further mounted on the controller substrate 120. The control device 10 may perform various types of control with the main processor 140 and the co-processor cooperating, or selectively with one of the main processor 140 and the co-processor.

The 6-axis sensor 111 is a motion sensor (inertial sensor) including a 3-axis acceleration sensor and a 3-axis gyro (angular velocity) sensor. The 6-axis sensor 111 may employ an Inertial Measurement Unit (IMU) that is a module including the sensors described above. For example, the magnetic sensor 113 is a 3-axis geomagnetic sensor.

The 6-axis sensor 111 and the magnetic sensor 113 output detection values to the main processor 140 at a predetermined sampling cycle. The 6-axis sensor 111 and the magnetic sensor 113 also output the detection values to the main processor 140 at a timing designated by the main processor 140, in response to a request from the main processor 140.

The GPS receiver 115 includes a GPS antenna (not illustrated) to receive a GPS signal transmitted from a GPS satellite. The GPS receiver 115 outputs the received GPS signal to the main processor 140. The GPS receiver 115 measures a signal strength of the received GPS signal, and outputs information on the signal strength to the main processor 140. Examples of the signal strength include information such as a Received Signal Strength Indication (RSSI), electric field intensity, magnetic field intensity, and Signal to Noise ratio (SNR).

The communication unit 117 performs wireless communications with external devices. The communication unit 117 includes an antenna, a radio frequency (RF) circuit, a baseband circuit, a communication control circuit, and the like, or is a device having these components integrated. The communication unit 117 performs wireless communications supporting standards such as Bluetooth or WLAN (including Wi-Fi).

The sound I/F 180 is an I/F that receives and outputs a sound signal. In the first exemplary embodiment, the sound I/F 180 includes the connector 46 (FIG. 1) provided to the connection cable 40. The connector 46 is connected to a headset 30. The right earphone 32 and the left earphone 34 output sounds upon receiving the sound signal output from the sound I/F 180. The microphone 63 of the headset 30 collects sounds and outputs the resultant sound signal to the sound I/F 180. The sound signal input from the microphone 63 to the sound I/F 180 is input to the external connector 184.

The sound codec 182 is connected to the sound I/F 180 and encodes and decodes the sound signal received and output via the sound I/F 180. The sound codec 182 may include an A/D converter that converts an analog sound signal to digital sound data and a D/A converter that performs the opposite conversion. For example, the HMD 100 according to the first exemplary embodiment outputs sounds with the right earphone 32 and the left earphone 34, and collects the sounds with the microphone 63. The sound codec 182 converts the digital sound data, output from the main processor 140, into an analog sound signal, and outputs the signal through the sound I/F 180. The sound codec 182 also converts the analog sound signal input to the sound I/F 180 into digital sound data, and outputs the data to the main processor 140.

The external connector 184 is a connector to which an external device that communicates with the main processor 140 is connected. For example, the external connector 184 is an I/F for connecting an external device, for debugging a program executed by the main processor 140 and collecting logs of operations performed by the HMD 100, to the main processor 140.

The external memory I/F 186 is an I/F enabling a portable memory device to be connected, and includes a memory card slot and an I/F circuit, so that a card shaped recording medium is attached to have data read, for example. With such a configuration, the size, the shape, and the standard of the card shaped recording medium are not limited and can be changed as appropriate.

The USB connector 188 include a connector and an I/F circuit supporting the USB standard. A USB memory device, a smartphone, a computer, and the like can be connected to the USB connector 188. The size and the shape of the USB connector 188 as well as the version of the supported USB standard can be selected and changed as appropriate.

The sensor hub 192 and the FPGA 194 are connected to the image display unit 20 via the I/F 196. The sensor hub 192 acquires detection values from various sensors of the image display unit 20, and outputs the detection values to the main processor 140. The FPGA 194 is in charge of processing data transmitted and received to and from the components of the image display unit 20, and transmitting via the I/F 196.

The LED indicator 12 turns ON and blinks in accordance with the operation status of the HMD 100. The LED display unit 17 controls the LED indicator 12 to turn ON and OFF, according to control performed by the main processor 140. The LED display unit 17 may include an LED (not illustrated) disposed immediately below the trackpad 14 and a driving circuit that turns ON the LED. With this configuration, the LED display unit 17 turns ON/OFF the LED or makes the LED blink, according to control performed by the main processor 140.

The vibrator 19 may include a motor and an eccentric rotor (none of which are illustrated) as well as any other required components. The vibrator 19 rotates the motor according to control performed by the main processor 140 to produce vibrations. For example, the HMD 100 vibrates under a predetermined vibration pattern by means of the vibrator 19, upon detecting an operation on the operation unit 110, when the HMD 100 is turned ON or OFF, or in the other like situations.

The operation unit 110 includes the operator 13 and the trackpad 14. The operator 13 includes the operation buttons 11, the up and down keys 15, the changeover switch 16, and the power switch 18. When the operator 13 or the trackpad 14 receives an operation, the operation unit 110 outputs an operation signal to the control unit 150. The operation signal includes identification information on the operator 13 or the trackpad 14 that has received the operation and information indicating the content of the received operation.

The control device 10 includes the power source unit 130, and operates with power supplied from the power source unit 130. The power source unit 130 includes a rechargeable battery 132 and a power source control circuit 134 that detects a remaining battery level of the battery 132 and controls charging of the battery 132. The power source control circuit 134 is connected to the main processor 140, and outputs a detection value indicating the remaining battery level of the battery 132 or a voltage detection value to the main processor 140. The control device 10 may supply power to the image display unit 20, based on power supplied by the power source unit 130. The main processor 140 may be capable of controlling a status of power supply from the power source unit 130 to the components of the control device 10 and the image display unit 20.

The right display unit 22 and the left display unit 24 of the image display unit 20 are each connected to the control device 10. As illustrated in FIG. 1, the HMD 100 includes the connection cable 40 connected to the left holding unit 23, wiring leading to the connection cable 40 provided in the image display unit 20, and the right display unit 22 and the left display unit 24 each connected to the control device 10.

The right display unit 22 includes a display unit substrate 210. An I/F 211 connected to the I/F 196, a receiver (Rx) 213 that receives data input from the control device 10 via the I/F 211, and an Electrically Erasable Programmable Read-Only Memory (EEPROM) 215 are mounted on the display unit substrate 210.

The receiver 213, the EEPROM 215, the temperature sensor 217, the camera 61, an illuminance sensor 65, and an LED indicator 67 are connected to the control device 10 via the I/F 211.

The EEPROM 215 stores various types of data to be readable by the main processor 140. For example, the EEPROM 215 stores data on light emission characteristics and display characteristics of the OLED units 221 and 241 of the image display unit 20, data on characteristics of the sensors of the right display unit 22 or the left display unit 24, and the like. More specifically, the data stored includes parameters related to gamma correction for the OLED units 221 and 241, data for compensating the detection values obtained by the temperature sensors 217 and 239, and the like. These pieces of data are generated through inspection performed when the HMD 100 is shipped from the factory to be written to the EEPROM 215 so that the main processor 140 can use the data in the EEPROM 215 to execute processing after the shipping.

The camera 61 captures an image according to a signal received via the I/F 211, and outputs captured image data or a signal indicating an image capturing result to the control device 10.

As illustrated in FIG. 1, the illuminance sensor 65 is provided to the end portion ER of the front frame 27 and is configured to receive external light from the front side of the user wearing the image display unit 20. The illuminance sensor 65 outputs a detection value corresponding to the amount (intensity) of the received light.

As illustrated in FIG. 1, the LED indicator 67 is disposed in the neighborhood of the camera 61 in the end portion ER of the front frame 27. The LED indicator 67 is ON while the camera 61 is capturing an image, and thus indicates that image capturing is being performed.

The temperature sensor 217 detects a temperature, and outputs a detection value that is a voltage value or a resistance value corresponding to the detected temperature. The temperature sensor 217 is mounted on the back surface side of the OLED panel 223 (FIG. 2). For example, the temperature sensor 217 may be mounted on a substrate on which the OLED driving circuit 225 is also mounted. With this configuration, the temperature sensor 217 mainly detects the temperature of the OLED panel 223.

The receiver 213 receives data transmitted by the main processor 140 via the I/F 211. Upon receiving image data on an image to be displayed on the OLED unit 221, the receiver 213 outputs the received image data to the OLED driving circuit 225 (FIG. 2).

The left display unit 24 includes a display unit substrate 230. An I/F 231 connected to the I/F 196 and a receiver (Rx) 233 that receives data input from the control device 10 via the I/F 231 are mounted on the display unit substrate 230. A 6 axis sensor 235 and a magnetic sensor 237 are also mounted on the display unit substrate 230. The I/F 231 connects the receiver 233, the 6-axis sensor 235, the magnetic sensor 237, and the temperature sensor 239 to the control device 10.

The 6-axis sensor 235 is a motion sensor (inertial sensor) including a 3-axis acceleration sensor and a 3-axis gyro (angular velocity) sensor. The 6 axis sensor 235 may employ IMU that is a module including the sensors described above. For example, the magnetic sensor 237 is a 3-axis geomagnetic sensor.

The temperature sensor 239 detects a temperature, and outputs a detection value that is a voltage value or a resistance value corresponding to the detected temperature. The temperature sensor 239 is mounted on the back surface side of the OLED panel 243 (FIG. 2). For example, the temperature sensor 239 may be mounted on a substrate on which the OLED driving circuit 245 is also mounted. With this configuration, the temperature sensor 239 mainly detects the temperature of the OLED panel 243. The temperature sensor 239 may be incorporated in the OLED panel 243 or the OLED driving circuit 245. The substrate may be a semiconductor substrate. Specifically, when the OLED panel 243 as a Si-OLED is mounted on an integrated semiconductor chip together with the OLED driving circuit 245 and the like to be an integrated circuit, the temperature sensor 239 may be mounted on the semiconductor chip.

The camera 61, the illuminance sensor 65, and the temperature sensor 217 of the right display unit 22 as well as the 6-axis sensor 235, the magnetic sensor 237, and the temperature sensor 239 of the left display unit 24 are connected to the sensor hub 192.

The sensor hub 192 sets and resets the sampling cycle of the sensors according to control performed by the main processor 140. The sensor hub 192 energizes the sensors, transmits control data to the sensors, acquires the detection values from the sensors, and perform the other like operations, based on the sampling cycles of the sensors. The sensor hub 192 outputs the detection value, acquired from each of the sensors of the right display unit 22 and the left display unit 24, to the main processor 140 at a timing set in advance. The sensor hub 192 may have a function of temporarily holding the detection value acquired from each sensor, based on a timing at which the value is output to the main processor 140. The sensor hub 192 may have a function of converting output values from the sensors with different signal formats or data formats into data with a unified data format, and transmit the data to the main processor 140.

The sensor hub 192 starts and stops energizing the LED indicator 67 according to control performed by the main processor 140, so that the LED indicator 67 turns ON or blinks at a timing at which the camera 61 starts or stops the image capturing.

FIG. 5 is a functional block diagram illustrating a storage unit 160 and a control unit 150 forming a control system of the control device 10. The storage unit 160 illustrated in FIG. 5 is a logical storage unit formed of the nonvolatile storage unit 123 (FIG. 4), and may include the EEPROM 215 and the memory 121. The control unit 150 and various functional units of the control unit 150 are implemented through a cooperation between software and hardware, when the main processor 140 executes a program. For example, the control unit 150 and various functional units of the control unit 150 include the main processor 140, the memory 121, and the nonvolatile storage unit 123.

The storage unit 160 stores a control program executed by the control unit 150 and various types of data processed by the control unit 150. Specifically, the storage unit 160 stores a control program 161, setting data 162, content data 163, a display position table 164, captured image data 165, and the like.

The control program 161 is an application program having a particular function executed on an Operating System (OS) 151. For example, the application program includes browser software, a business program, an office program such as word processing software and spreadsheet software, and the like. The application program includes a program for detecting a gesture defined by the movement, shape, and position of a hand of the user, and executing processing associated with the detected gesture. An operation performed when the control unit 150 executes the application program will be described in detail later.

The setting data 162 includes various setting values for configuring the operation performed by the HMD 100. In a case where the control unit 150 uses a parameter, determinant, formula, Lookup Table (LUT), and the like to control the HMD 100, the setting data 162 may include these pieces of data.

The content data 163 is data on contents including a display image or video to be displayed by the image display unit 20 based on control performed by the control unit 150, and includes image data or video data. The content data 163 may include music or sound data.

The content data 163 may be data on bidirectional contents. Specifically, the image display unit 20 displays image data or video date in the content data 163, the operation unit 110 receives an operation on the image data or the video data displayed, and the control unit 150 executes processing corresponding to the received operation. In this case, the content data 163 may include image data on a menu screen displayed for receiving operations, data for determining processing corresponding to an item on the menu screen, and the like.

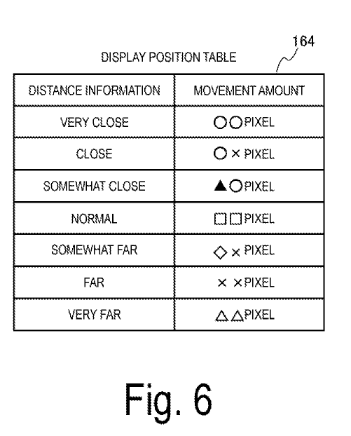

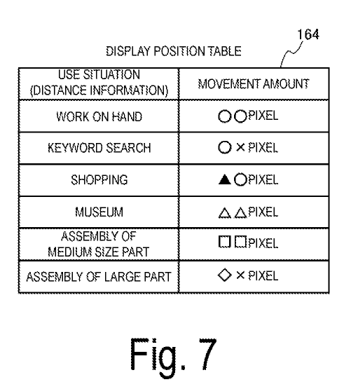

FIG. 6 and FIG. 7 illustrates a display position table 164.

In the display position table 164, distance information representing a visual recognition distance and a movement amount of a display position are registered while being associated with each other. The visual recognition distance is information indicating a distance between a user who performs an operation and an actual object that is a target of the operation visually recognized by the user.

The information on the movement amount of the display position is as follows.

Generally, in a case where the actual object is visually recognized with both right and left eyes, a convergence angle is large when the actual object to be visually recognized is close to the eyes and is small when the actual object to be visually recognized is far. Based on this principle, the display position of an image is shifted (moved) by correction software processing to change the convergence angle of the user's eyes, so that the focal distance is changed for the image visually recognized by the user. The movement amount of the display position is an amount of movement of the display position of the image for changing the focal distance.

In the display position table 164 illustrated in FIG. 6, seven pieces of distance information “very close”, “close”, “somewhat close”, “normal”, “somewhat far”, “far”, and “very far” are registered. These pieces of information are constructed by a natural language stepwisely indicating the visual recognition distance. In the display position table 164, a movement amount corresponding to each distance information is registered.

In the display position table 164 illustrated in FIG. 7, use situation that is information indicating a work and operation performed by the user is registered as the distance information. For example, pieces of information indicating work on hand, keyword search, shopping, museums (art appreciation), assembly of medium size parts, assembly of large parts, and the like are registered. These pieces of information indicate the use situations of the HMD 100. The movement amount corresponding to the work and operation is also registered in the display position table 164 illustrated in FIG. 7.

In the first exemplary embodiment, the display position table 164 is generated by the manufacturer of the HMD 100, and is stored in the storage unit 160 at the time of product shipping. The display position table 164 may be downloaded from a server device provided by the manufacturer to be stored in the storage unit 160. The movement amount registered in the display position table 164 may be correctable by the user through an operation on the operation unit 110 or the like.

The captured image data 165 is data on an image captured by the camera 61. The captured image data 165 is temporarily stored in the storage unit 160, and is deleted from the storage unit 160 when the processing by the control unit 150 is terminated, for example.

The control unit 150 executes various types of processing by using data stored in the storage unit 160, to control the HMD 100. The control unit 150 includes the OS 151, an image processing unit 152, an image capturing control unit 153, a detection control unit 154, a display control unit 155, and a processing control unit 156 as functional blocks. The functional blocks are blocks representing functions implemented when the main processor 140 executes a control program only for the sake of description, and do not represent any particular application program or hardware. The image capturing control unit 153 and the detection control unit 154 correspond to the “input unit” of the disclosure.

The function of the OS 151 is a function of the control program stored in the storage unit 160, and is a function of an application program executed on the OS 151.

For example, the image processing unit 152 reads the content data 163 from the storage unit 160, and extracts synchronization signals, such as a vertical synchronization signal VSync and a horizontal synchronization signal HSync, from the content data 163 thus read. The image processing unit 152 generates a clock signal PCLK by using a Phase Locked Loop (PLL) circuit and the like (not illustrated), based on cycles of the vertical synchronization signal VSync and the horizontal synchronization signal HSync extracted. The image processing unit 152 may execute various types of image processing including resolution conversion, luminance and/or saturation adjustment, and 2D/3D conversion, as appropriate.

The image processing unit 152 loads the image data, as a result of the image processing, onto a DRAM in the storage unit 160, on a frame by frame basis. A frame is a unit for displaying an image. An area of the DRAM on which one frame of the image data is loaded is hereinafter referred to as a frame area. The image processing unit 152 reads image data from a frame area, and outputs the image data thus read as the display image data to the image display unit 20.

The image processing unit 152 may be implemented by the main processor 140 executing a program or may be implemented in hardware (a digital signal processor (DSP) for example) different from the main processor 140.

The image capturing control unit 153 performs control to cause the camera 61 to capture an image and generate captured image data. The image capturing control unit 153 temporarily stores the captured image data thus generated, in the storage unit 160. In a case where the camera 61 is formed as a camera unit including a circuit that generates captured image data, the image capturing control unit 153 acquires the captured image data from the camera 61, and temporarily stores the captured image data in the storage unit 160.

The detection control unit 154 reads the captured image data from the storage unit 160, and detects a captured image of a marker in the captured image data thus read.

For example, the marker may be any real object in real space that can be imaged by the camera 61. Examples of the marker include a one-dimensional code such as a barcode or a two-dimensional code such as a QR code (trade name). The marker is preferably a real object associated with a use situation of the user. For example, in a case where the use situation of the HMD 100 used by the user is a product assembly line, the marker may be letters or signs for identifying an assembly process or may be a part actually used in the assembly. In a case where the use situation of the HMD 100 used by the user is shopping in a supermarket or the like, the marker may be a product displayed in the supermarket, the sign of the supermarket, a product display shelf, a shopping basket, or a shopping cart. In a case where the use situation of the HMD 100 used by the user is art appreciation in a museum, the marker may be a frame of a painting that is an artwork.

The display control unit 155 generates a control signal for controlling the right display unit 22 and the left display unit 24, and uses the control signal thus generated to control generation and emission of image light from each of the right display unit 22 and the left display unit 24. Specifically, the display control unit 155 controls the OLED driving circuits 225 and 245 to cause the OLED panels 223 and 243 to display an image. The display control unit 155 controls a timing of rendering on the OLED panels 223 and 243 by the OLED driving circuits 225 and 245, controls the luminance on the OLED panels 223 and 243, and performs the other like control based on the signal output from the image processing unit 152.

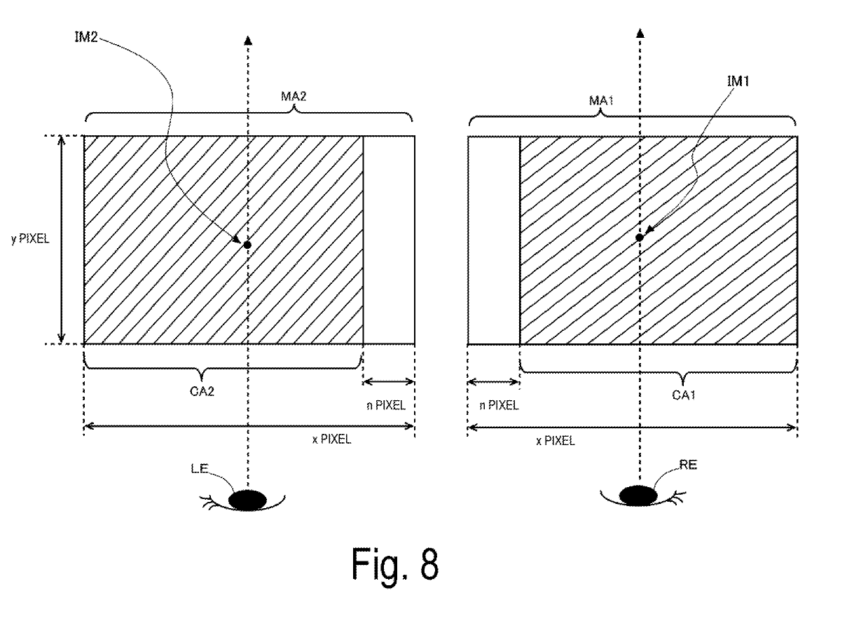

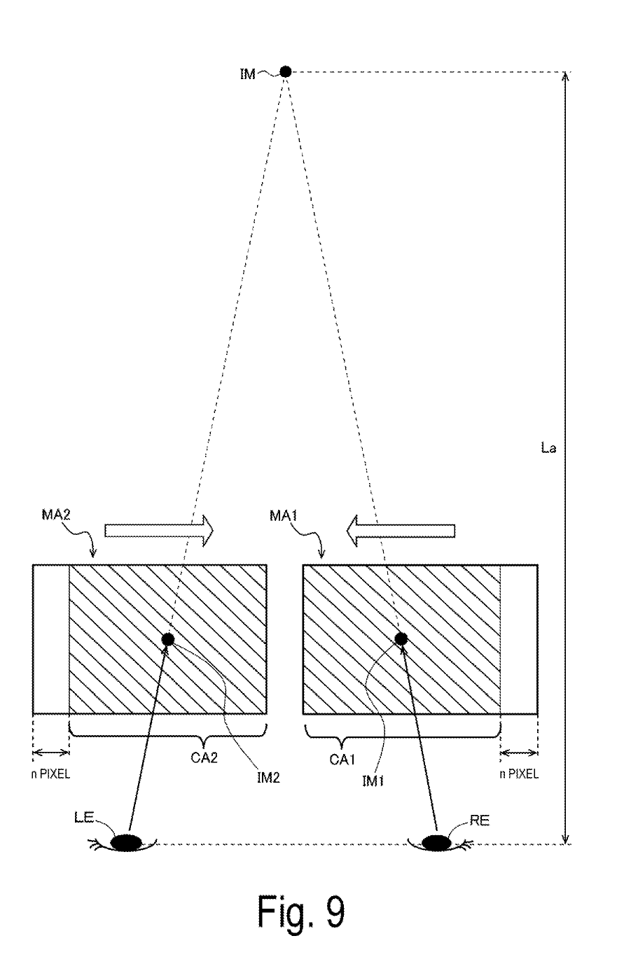

FIG. 8 is a diagram illustrating relationship between a size of a reference region and a size of an emission region. FIG. 9 is a diagram illustrating an image formed based on image light emitted from the display unit, with a focal distance La.

The display control unit 155 refers to the display position table 164, and acquires a movement amount associated with the distance information. Then, the display control unit 155 moves emission regions CA1 and CA2 of the right display unit 22 and the left display unit 24 by the acquired movement amount. As a result, the focal distance is adjusted. The emission region CA1 of the right display unit 22 corresponds to a “right display region” of the disclosure, and the emission region CA2 of the left display unit 24 corresponds to a “left display region” of the disclosure.

The reference region represents a region of the right display unit 22 and the left display unit 24 from which the image light is emitted. More specifically, for example, the reference region may be set to be slightly smaller than the maximum possible region of the right display unit 22 and the left display unit 24 for emitting the image light, or may be the maximum region.

The reference region may be defined as a part or the entirety of a region of each of the OLED unit 221 of the right display unit 22 and the OLED unit 241 of the left display unit 24, where an image can be formed. Alternatively, the reference region may be a part or the entirety of a region with which the right display unit 22 and the left display unit 24 are capable of irradiating the half mirrors 261 and 281 with the image light. The reference region may be a region with which the right eye RE and the left eye LE are irradiated with the image light from the half mirrors 261 and 281, with light emitted from the right display unit 22 and the left display unit 24, or may be a region where a virtual image is formed on the half mirrors 261 and 281.

In the example illustrated in FIG. 8, the size of a reference region MA1 in the right display unit 22 corresponding to the right eye RE of the user is x pixels× y pixels. In the example illustrated in FIG. 8, the size of a reference region MA2 in the left display unit 24 corresponding to the left eye LE of the user is x pixels×y pixels.

In FIG. 8, a hatched region represents the emission region, in each of the right display unit 22 and the left display unit 24, from which the image light is actually emitted. In the first exemplary embodiment, the emission region is smaller than the reference region in the horizontal direction (lateral direction). Specifically, the size of the emission region CA1 in the right display unit 22 corresponding to the right eye RE of the user is x−n pixels×y pixels, and is set to be smaller than the reference region MA1 in the horizontal direction. Specifically, the size of the emission region CA2 in the left display unit 24 corresponding to the left eye LE of the user is x−n pixels×y pixels, and is set to be smaller than the reference region MA2 in the horizontal direction.

For example, when the focal distance is adjusted to be the maximum focal distance (infinity), the movement amount of the emission region is “0 (pixels)”. As a result, an image IM1 visually recognized with the right eye RE of the user based on the image light emitted from the emission region CA1 and an image IM2 visually recognized with the left eye LE of the user based on the image light emitted from the emission region CA2 are in a parallel view state as illustrated in FIG. 8. Thus, the infinite focal distance is achieved.

FIG. 9 is a diagram illustrating an image formed based on the image light emitted from the right display unit 22 and the left display unit 24, with the focal distance La.

The movement amount of the emission region for adjustment to achieve the focal distance La is assumed to be “n (pixels)”. The display control unit 155 moves the emission region CA1 in the right display unit 22 corresponding to the right eye RE of the user and the emission region CA2 in the left display unit 24 corresponding to the left eye LE in directions toward the glabella of the user (directions indicated by white arrows in FIG. 9) in an interlocked manner. As a result, the image IM1, based on the image light emitted from the emission region CA1, visually recognized with the right eye RE of the user and the image IM2, based on the image light emitted from the emission region CA2, visually recognized with the left eye LE of the user are captured with the focal point at a position (IM) separated from each of the eyes of the user by the distance La. Thus, adjustment to achieve a target focal distance is implemented.

As described above, an image formed based on the image light emitted from one of the display units (22 or 24) and an image formed based on the image light emitted from the other one of the display units (24 or 22) are moved toward (or away from) each other in an interlocked manner. As a result, the convergence angle between the right eye RE and the left eye LE of the user relative to images formed based on both rays of the image light increases (decreases). Thus, the user of the HMD 100 is capable of perceiving the image on a closer (farther) side. Thus, the focal distance is capable of being adjusted by adjusting the convergence angle between the lines of sight of the right eye RE and the left eye LE of the user.

The right display unit 22 and the left display unit 24 may be adjusted in such a manner that an image displayed on the right display region and an image displayed on the left display region are controlled independently from each other. The focal distance of the image is capable of being adjusted more in detail with the right display unit 22 and the left display unit 24 controlled independently from each other.

The processing control unit 156 controls an operation of a control target device, according to control performed by the detection control unit 154. The processing control unit 156 executes an application program to execute processing, according to control performed by the detection control unit 154. Examples of the device controlled by the processing control unit 156 include the microphone 63, the 6-axis sensors 111 and 235, the magnetic sensors 113 and 237, the temperature sensors 217 and 239, the illuminance sensor 65, the LED indicators 12 and 67, and the like. Examples of the processing executed by executing an application program include processing of playing the content data 163 such as a movie or music. The processing executed by executing an application program further includes processing of starting browser software as the application program and processing of executing a search based on a keyword input to a search field of the browser software.

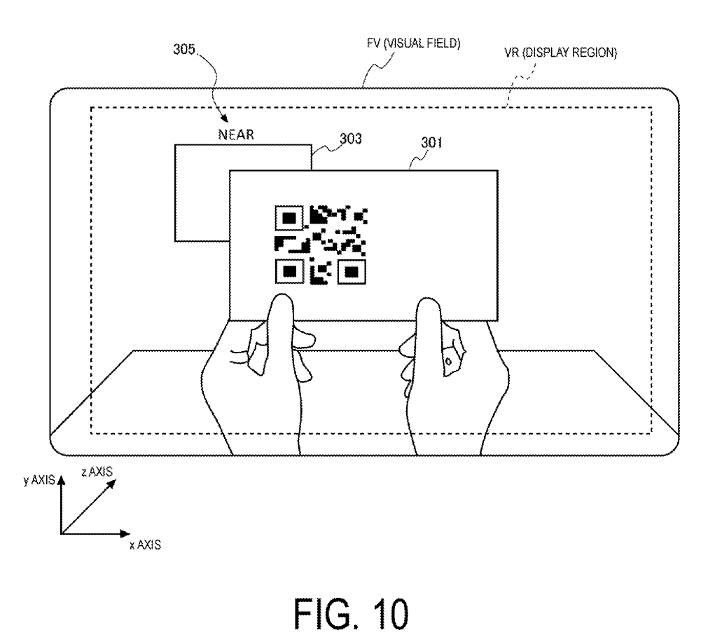

FIG. 10 illustrates the visual field range FV and the display region VR. The visual field range FV represents a visually recognizable range of the user wearing the image display unit 20 on his or her head. An x-axis direction, a y-axis direction, and a z-axis direction respectively represent a width direction, a height direction, and a depth direction of the visual field range FV. The display control unit 155 controls the right display unit 22 and the left display unit 24 to adjust the display positions of the image in the depth direction, and thus adjusts the focal distance of the image.

The user of the HMD 100 that is a see-through display type device can simultaneously visually recognize both a real object in real space and an image displayed by the image display unit 20, in the visual field range FV. For example, FIG. 10 illustrates a state where the hands of the user and a sheet 301 on which a QR code is printed are visually recognized as real objects, and a frame shaped image (hereinafter, referred to as a frame image 303) is visually recognized as the image.

The user moves the sheet 301 held by his or her hands so that the QR code is positioned within the frame image 303. The display control unit 150 acquires an image of the QR code captured within the frame image 303, from the captured image data obtained by the camera 61, and acquires information indicated by the QR code.

The user wearing the image display unit 20 on his or her head for art appreciation in a museum may simultaneously visually recognize a displayed artwork and a descriptive text, for the displayed artwork, displayed by the image display unit 20.

The user gazing at both the image displayed by the HMD 100 and a real object might fail to simultaneously view both image and object or might view a double image imposing a large strain on the user's eyes, when the difference between the image and the real object in the focal distance is large.

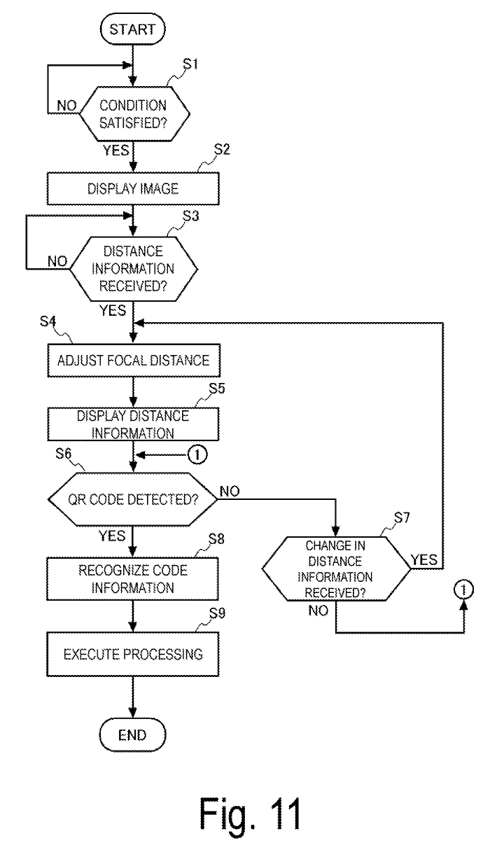

FIG. 11 is a flowchart illustrating processing executed by the control unit 150. More specifically, the flowchart illustrates processing of adjusting the focal distance for the image displayed by the image display unit 20 and the real object.

First of all, the display control unit 165 determines whether a predetermined condition has been satisfied (step S1). Examples of the predetermined condition include conditions that are satisfied when the application program starts, when operation on the operation unit 110 including the trackpad 14 and the like is received, and when a sound matching a predetermined keyword or the like is input with the microphone 63.

When the predetermined condition is not satisfied (step S1/NO), the display control unit 165 stands by until the predetermined condition is satisfied. When the predetermined condition is satisfied (step S1/YES), the display control unit 165 displays an image on the display region VR (step S2). Here, an example where the frame image 303 is displayed as illustrated in FIG. 10 will be described.

Next, the display control unit 165 determines whether distance information has been input through an operation on the operation unit 110 or through sound input using the microphone 63 (step S3). For example, the display control unit 165 may determine the distance information based on the number of times the trackpad 14 serving as the operation unit 110 is tapped or through a sound input through the microphone 63. When the distance information has not been input yet (step S3/NO), the control unit 150 stands by until the distance information is input.

When the distance information is input (step S3/YES), the display control unit 165 refers to the display position table 164 to acquire a movement amount associated with the distance information received. After acquiring the movement amount, the display control unit 165 controls the image display unit 20 according to the acquired movement amount to adjust the focal distance of the frame image 303 (step S4). The display control unit 165 displays the distance information indicating the adjusted focal distance on the display region VR (step S5). FIG. 10 illustrates an example where “close” as a text 305 indicating the focal distance is displayed.

Next, the display control unit 165 extracts an image of a region of the captured image of the frame image 303 from the captured image data obtained by the camera 61, and determines whether the image of the QR code is detected in the image thus extracted (step S6). When the image of the QR code fails to be detected (step S6/NO), the display control unit 165 determines whether an operation for changing the distance information has been received (step S7). When the operation for changing the distance information has been received (step S7/YES), the display control unit 165 returns to the processing in step S4 to adjust the focal distance. When the operation for changing the distance information has not been received (step S7/N0), the display control unit 165 returns to step S6 to determine whether the image of the QR code is detected (step S6).

When the image of the QR code is detected (step S6/YES), the display control unit 165 recognizes code information based on the image of the QR code detected (step S8), and transfers the code information thus recognized to the processing control unit 156. The processing control unit 156 executes processing corresponding to the code information transferred from the display control unit 155 (step S9). For example, the processing control unit 156 accesses a website indicated by the code information, and displays the webpage of the website on the display region VR.

In the description above, the distance information input through an operation on the operation unit 110 or the like is received, and the display control unit 165 adjusts the focal distance of the image displayed by the image display unit 20 to be the focal distance corresponding to the distance information thus received.

In one modification, the display control unit 165 may determine the use situation of the HMD 100 based on the captured image data obtained by the camera 61. More specifically, the display control unit 165 detects an image registered as a marker from the captured image data, and refers to the display position table 164 to acquire the movement amount of the display position associated with the image of the marker thus detected. The display control unit 165 adjusts the focal distance of the image displayed on the display region VR according to the movement amount of the display position thus acquired.

For example, the display control unit 165 identifies the current position of the user based on the GPS signal received by the GPS receiver 115, when an image of a frame of a panting as an artwork is detected. The display control unit 165 identifies the museum based on the identified current position of the user, and acquires a description on the museum or the artwork from the Website of the museum thus identified. Then, the display control unit 165 displays an image of the descriptive text for the museum or the artwork on the display region VR. In this case, the display control unit 165 acquires the movement amount of the display position corresponding to the museum as the use situation, and adjusts the focal distance of the image of the descriptive text displayed on the display region VR, according to the movement amount of the display position thus acquired.

In a case where an image of a part assembled in a production line is detected in the captured image data, the display control unit 165 reads a manual describing an assembly procedure for the detected part from the storage unit 160. Then, the display control unit 165 displays the image of the descriptive message on the display region VR. In this case, the display control unit 165 acquires the movement amount of the display position corresponding to the part assembly as the use situation, and adjusts the focal distance of the image of the descriptive text displayed on the display region VR, according to the movement amount of the display position thus acquired.

As described above, the HMD 100 according to the present embodiment includes the image display unit 20 serving as a display unit, the operation unit 110 or the camera 61 serving as the input unit, the control unit 150, and the storage unit 160.

The image display unit 20 is mounted on the head of the user, is configured to enable the user to visually recognize the outside scene through the image display unit 20, and displays an image on the display region VR to be overlapped with the outside scene. The operation unit 110 receives an operation. The control unit 150 controls the display position of the image displayed on the display region VR. The storage unit 160 stores display position information including: distance information indicating a visual recognition distance perceived by the user with respect to the image displayed on the display region VR; and a display position of the image displayed on the display region VR or the movement amount of the display position associated with the distance information. The control unit 150 selects the distance information based on the operation received by the operation unit 110 or the image of the marker captured by the camera 61. The control unit 150 controls the display position of the image displayed on the display region VR according to the display position of the image or the movement amount of the display position associated with the selected distance information by the display position information.

With this configuration, an image is displayed with a small difference in the focal distance with respect to an object in the neighborhood of the point corresponding to the distance indicated by the selected distance information, whereby a strain on the user's eyes is reduced.

When the information designating the distance information is received through the operation unit 110, the control unit 150 controls the display position of the image displayed on the display region VR, according to the display position of the image or the movement amount of the display position associated with the designated information by the display position information.

With this configuration, an image is displayed with a small difference in the focal distance with respect to an object in the neighborhood of the point corresponding to the distance indicated by the selected distance information, whereby a strain on the user's eyes is reduced.

The storage unit 160 stores the use situation of the HMD 100 and the distance information in association with each other. When the use situation is designated based on the operation received by the operation unit 110 or the image of the marker captured by the camera 61, the control unit 150 identifies the distance information corresponding to the use situation designated. The control unit 150 controls the display position of the image displayed on the display region VR according to the display position of the image or the movement amount of the display position associated with the identified distance information by the display position information.

With this configuration, an image is displayed with a small difference in the focal distance with respect to an object in the neighborhood of the point corresponding to the distance corresponding to the designated use situation, whereby a strain on the user's eyes is reduced.

The storage unit 160 stores the use situation of the HMD 100 and the distance information in association with each other. The control unit 150 determines the use situation of the HMD 100 and identifies the distance information stored in the storage unit 160 while being associated with the use situation thus determined. The control unit 150 controls the display position of the image displayed on the display region VR according to the display position of the image or the movement amount of the display position associated with the identified distance information by the display position information.

With this configuration, an image is displayed with a small difference in the focal distance with respect to an object in the neighborhood of the point corresponding to the distance associated with the use situation, whereby a strain on the user's eyes is reduced.

The distance information is constructed by a natural language that stepwisely indicates the visual recognition distance.

Thus, the visual recognition distance is easily selected, and the display position of the image displayed on the display region VR is easily adjusted.

The distance information indicates the visual recognition distance perceived by the user, by using at least one of words including close, normal, and far.

Thus, the distance information is easily selected, and the display position of the image displayed on the display region VR is easily adjusted.

The control unit 150 controls the display position of the image displayed on the display region VR based on the distance information designated by an operation received by the operation unit 110, in a state where the distance information in the display position information is displayed by the image display unit 20.

With the distance information thus displayed, appropriate distance information is selected when a difference in the focal distance with respect to the displayed image is large.

The image display unit 20 includes the left display region corresponding to the left eye of the user and the right display region corresponding to the right eye of the user, and displays an image on each of the left display region and the right display region. The control unit 150 controls the display position of the image displayed on each of the left display region and the right display region.

Thus, adjustment to achieve an optimum display position of the image displayed by the image display unit 20 is implemented.

### Second Exemplary Embodiment

A second exemplary embodiment of the disclosure is described with reference to the accompanying drawings.

In the first exemplary embodiment described above, the display position table 164 is generated by the manufacturer of the HMD 100 and is stored in the storage unit 160 by the manufacturer at the time of product shipping.

In the second exemplary embodiment, the table is generated with an image of the marker captured by the camera 61.

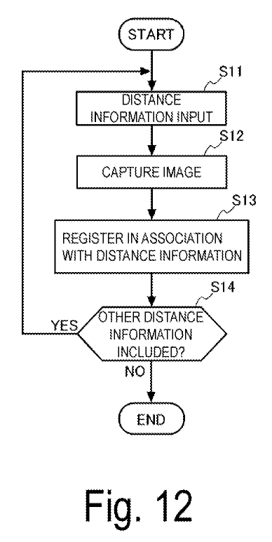

FIG. 12 is a flowchart illustrating operations in marker registration processing.

Upon receiving an operation for requesting for registration of the distance information, the control unit 150 executes the marker registration processing. When the marker registration processing starts, the control unit 150 refers to a setting file in which an image capturing distance of a marker is set, and selects one distance information registered in the setting file (step S11). Upon selecting one distance information, the control unit 150 displays a message such as “PLACE THE MARKER AT POSITION CORRESPONDING TO DISTANCE INDICATED BY DISTANCE INFORMATION” on the display region VR. The distance information may be provided with the user inputting a distance desired to be set by operating the operation unit 110.

The marker usable in the marker registration processing is not particularly limited as long as the marker is a real object, and is preferably a real object associated with the use situation of the user. The marker may be colored in black and a outside scene for capturing an image of the marker may be colored in white, so that the maker is detected with a higher accuracy.

The user places the real object to be the maker at the position corresponding to the set distance. The marker may be placed by making the distance to the marker measured by the user match the distance between the image display unit 20 and the marker. The user may rely on eye estimation to place the marker. For example, in a case where the predetermined distance is 5 m, the camera 61 may capture an image of the marker placed at a position estimated by the user to be distant by 5 m. With the marker placed based on the eye estimation, the focal distance of the image displayed by the image display unit 20 is positioned to be close to the sense of distance of the user.

After placing the marker, the user operates the operation unit 110 to capture the image of the marker with the camera 61 (step S12). The control unit 150 controls the image display unit 20 to display the captured image data on the image thus captured on the display region VR. The user may visually recognize the captured image data thus displayed, and change the image capturing position of the camera 61 so that the marker can be at the center of the captured image indicated by the captured image data.

The user may operate the trackpad 14 to change the display position of a pointer in the display region VR so that the pointer overlaps with the image of the marker, and then may press a confirmation button in the operation unit 110. The control unit 150 recognizes the image displayed at a position overlapping with the pointer as the marker when the confirmation button is pressed.

Upon receiving the confirmation operation, the control unit 150 stores the captured image data in the storage unit 160 (step S13). In this process, the control unit 150 stores the captured image data in the storage unit 160 in association with the distance information set in step S11. The distance information set in step S11 corresponds to “the display position of the image determined based on the input received by the input unit”. The captured image data obtained by the camera 61 corresponds to the “detection position of the marker detected by the detecting unit”. The captured image data and the distance information stored in the storage unit 160 while being associated with each other corresponds to “display control information” of the disclosure.

Next, the control unit 150 determines whether the setting file includes the other distance information that has not been selected (step S14). In a case of the configuration where the user operates the operation unit 110 to input the distance information, the control unit 150 may display a message such as “REGISTER IMAGE OF MARKER CORRESPONDING TO OTHER DISTANCE?” on the display region VR.

When the setting file includes the other distance information that has not been selected, the control unit 150 returns to step S11, and repeats the processing in steps S11 to S13. When the setting file does not include the other distance information that has not been selected (step S14/N0), the control unit terminates this processing flow.

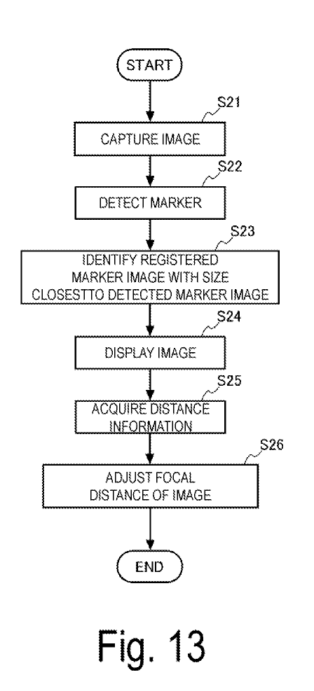

FIG. 13 is a flowchart illustrating processing executed by the control unit 150. More specifically, FIG. 13 illustrates a flow of detecting an image of a marker and display an image at a position corresponding to the focal distance of the marker image thus detected.

The control unit 150 causes the camera 61 to capture an image and generate captured image data (step S21). Next, the control unit 150 acquires the captured image data, analyzes the captured image data, and detects an image (hereinafter, referred to as detected marker image) of a marker registered in the maker registration processing illustrated in FIG. 12 (step S22). When the detected marker image is detected, the control unit 150 identifies a registered marker image with a size closest to that of the detected marker image thus detected (step S23). The registered marker image is an image of a marker stored in the storage unit 160 in association with the distance information in step S13.

Upon identifying the registered marker image with a size closest to that of the detected marker image, the control unit 150 refers to the storage unit 160 to acquire the distance information associated with the registered marker image. Next, the control unit 150 controls the image display unit 20 to display the image corresponding to the detected marker image (step S24). For example, in a case where the detected marker image is an image of a part assembled in a production line, the control unit 150 reads the manual describing an assembly procedure for the detected part from the storage unit 160. The control unit 150 displays an image of the descriptive text on the display region VR. In this process, the control unit 150 acquires the distance information registered in association with the registered marker image from the storage unit 160 (step S25). The control unit 150 controls the image display unit 20 to adjust the focal distance of the image displayed by the image display unit 20 to be a distance corresponding to the distance information acquired in step S25 (step S26).

As described above, in the second exemplary embodiment, the control unit 150 controls the display position of the image displayed on the display region VR, based on the detected position of the marker detected with the captured image data obtained by the camera 61 serving as the detecting unit.

Thus, the image is displayed with a small difference in the focal distance with respect to an object in the neighborhood of a position corresponding to the distance corresponding to the position of the detected marker, whereby a strain on the user's eyes is reduced.

The storage unit 160 stores display control information in which the detection position of the marker detected with the captured image data obtained by the camera 61 is correlated with the display position of the image displayed on the display region VR or the movement amount of the display position.

The control unit 150 obtains the display position of the image displayed on the display region VR or the movement amount of the display position by using the display control information stored in the storage unit 160, based on the detection position of the marker detected with the captured image data of the camera 61. The control unit 150 controls the display position of the image displayed on the display region VR.

Thus, the display position of the image is appropriately controlled based on the detection position of the marker.

The control unit 150 generates the display control information and stores the display control information in the storage unit 160. In the display control information, the detection position of the marker detected with the captured image data obtained by the camera 61 is associated with the display position of the image determined based on an operation received by the operation unit 110.

Thus, the display control information associating the detection position of the marker with the display position of the image is generated with a simple configuration. The display position of the image is set based on a sense of distance of the user.

The control unit 150 changes the display position of the image displayed on the display region VR with a plurality of steps so that the user can perceive the image displayed on the display region VR with different visual recognition distances. The control unit 150 generates the display control information and stores the display control information in the storage unit 160. In the display control information, the display position selected based on the operation received by the operation unit 110 is associated with the detection position of the marker detected with the captured image data obtained by the camera 61.

Thus, the image is displayed at positions with different visual recognition distances perceived by the user, based on the detection position of the marker.

The embodiments described above are embodiments appropriate for the technique of the disclosure. However, these embodiments should not be construed in a limiting sense, and can be modified in various ways without departing from the gist of the disclosure.

For example, in the embodiments described above, the distance information and the movement amount of the display position being registered in the display position table 164 is described. Alternatively, information indicating the display position of an image may be registered instead of the movement amount. Furthermore, coordinate information indicating rendering start position of an image may be registered as the display position of the image.

In the embodiment described above, the configuration where the control device 10 and the image display unit 20 are in wired connection is described as an example. However, the disclosure is not limited to this configuration, and a configuration where the control device 10 is in wireless connection with the image display unit 20 may be employed. This configuration may employ a communication system described as an example of the communication system supported by the communication unit 17, or may employ any other communication system.

The image display unit 20 may be in charge of a part of the functions of the control device 10, and the control device 10 may be implemented by a plurality of devices. Specifically, the control device 10 is not limited to a configuration with the box-shaped casing 10A. For example, a wearable device that can be attached to the body or clothing of the user, or to an accessory worn by the user may be used instead of the control device 10. For example, wearable device may be a watch-type device, a ring-type device, a laser pointer, a mouse, and air mouse, a game controller, a pen-type device, or the like.

In the embodiments described above, the configuration where the image display unit 20 and the control device 10 are separately provided and are connected to each other via the connection cable 40 is described as an example. However, the disclosure is not limited to this configuration, and a configuration where the control device 10 and the image display unit 20 are integrated to be mounted on the head of the user may be employed.

The control device 10 may be a laptop computer, a tablet computer, or a desktop computer. Furthermore, the control device 10 may portable electronic equipment including a game console, a mobile phone, a smartphone, and a portable media player, or may be other dedicated devices.

For example, an image display unit with a configuration different from that of the image display unit 20, such as an image display unit that is worn like a hat, may be employed, as long as the display unit that displays an image for the left eye LE of the user and the display unit that displays an image for the right eye RE are provided. A head-up display may be used instead of the image display unit 20 to be installed in a vehicle such as an automobile or an aircraft. For example, the head-up display is installed in a vehicle with an operation surface, serving as the operation surface of the trackpad 14, provided on a steering wheel of the vehicle or the like.

Furthermore, the disclosure may be applied to a head mounted display device incorporated in a body protector such as a helmet. In such a case, a position facing the body of the user may be referred to as a positioning portion and a portion positioned with respect to the portion may be referred to as a wearing portion.

In the example described above, the optical system that guides the image light to the eyes of the user has the configuration where virtual images are partially formed on the right light-guiding plate 26 and the left light-guiding plate 28 by the half mirrors 261 and 281. However, the disclosure is not limited to this configuration, and a configuration where the image is formed on a display region having an area entirely or mostly covering the right light-guiding plate 26 and the left light-guiding plate 28 may be employed. With this configuration, the processing of changing the display position of an image may include processing of downscaling the image.

The optical element of the disclosure is not limited to the right light-guiding plate 26 and the left light-guiding plate 28 including the half mirrors 261 and 281, and may be any optical part enabling the image light to be incident on the user's eyes. Specifically, a diffraction grating, a prism, or a holography display unit may be used.

At least a part of the functional blocks illustrated in FIG. 4, FIG. 5, and the like may be implemented with hardware or may be implemented with cooperation between hardware and software, and thus is not limited to the illustrated configuration where independent hardware resources are arranged. A program executed by the control unit 150 may be stored in the nonvolatile storage unit 123 or in the storage devices (not illustrated) in the control device 10. A configuration where a program stored in an external device is acquired through the communication unit 117 and the external connector 184 to be executed may be employed. The operation unit 110, in the configuration formed in the control device 10, may be formed as a user interface (UI).

The flowcharts illustrated in FIG. 11 to FIG. 13 are divided into processing units based on main processing contents, so that the processing executed by the control unit 150 of the HMD 100 can be easily understood. Thus, the disclosure is not limited to how the processing is divided into process units or the names of the process units. The processing executed by the control unit 150 may be divided more in detail so that more process units are provided, or may be divided so that a single process unit include more processes. The processing order in the flowcharts described above is not limited to the illustrated examples.

What is claimed is:

1. A head mounted display device comprising:
a display unit that is mounted on a head of a user, configured to enable an outside scene to be visually recognized through the display unit, and displays an image on a display region overlapping with the outside scene;
an input unit configured to receive an input;
a control unit configured to control a display position of the image displayed on the display region; and
a storage unit configured to store display position information including:
distance information indicating a visual recognition distance perceived by the user for the image displayed on the display region; and
the display position of the image displayed on the display region or a movement amount of the display position associated with the distance information, wherein
the control unit selects the distance information based on the input received by the input unit, and controls the display position of the image displayed on the display region according to the display position of the image or the movement amount of the display position associated with the selected distance information by the display position information.

2. The head mounted display device according to claim 1, wherein when the distance information is designated by the input received by the input unit, the control unit controls the display position of the image displayed on the display region according to the display position of the image or the movement amount of the display position associated with the designated distance information by the display position information.

3. The head mounted display device according to claim 1, wherein
the storage unit stores use information related to a use situation of the head mounted display device in association with the distance information, and
when the use information is designated by the input received by the input unit, the control unit identifies the distance information corresponding to the designated use information, and controls the display position of the image displayed on the display region according to the display position of the image or the movement amount of the display position associated with the identified distance information by the display position information.

4. The head mounted display device according to claim 1, wherein
the storage unit stores use information related to a use situation of the head mounted display device in association with the distance information, and
the control unit determines the use situation of the head mounted display device, identifies the distance information stored in the storage unit in association with the use information corresponding to the determined use situation, and controls the display position of the image displayed on the display region according to the display position of the image or the movement amount of the display position associated with the identified distance information by the display position information.

5. The head mounted display device according to claim 1, wherein the distance information is constructed by a natural language that stepwisely indicates the visual recognition distance.

6. The head mounted display device according to claim 5, wherein the distance information indicates the visual recognition distance perceived by the user, by using at least one of words including close, normal, and far.

7. The head mounted display device according to claim 1, wherein the control unit controls the display position of the image displayed on the display region based on the distance information designated by the input received by the input unit, in a state where the distance information in the display position information is displayed by the display unit.

8. The head mounted display device according to claim 1, wherein the display unit includes a left display region corresponding to a left eye of the user and a right display region corresponding to a right eye of the user, and displays an image on each of the left display region and the right display region, and
the control unit respectively controls a display position of the image displayed on the left display region and a display position of the image displayed on the right display region.

9. A head mounted display device comprising:
a display unit that is mounted on a head of a user, configured to enable an outside scene to be visually recognized through the display unit, and displays an image on a display region overlapping with the outside scene;
a detecting unit configured to detect a marker at least in a range visually recognized through the display unit; and
a control unit configured to control a display position of an image displayed on the display region, wherein
the control unit controls the display position of the image displayed on the display region based on a detection position of the marker detected by the detecting unit.

10. The head mounted display device according to claim 9, A storage unit configured to store display control information in which the detection position of the marker detected by the detecting unit is correlated with a display position of the image displayed on the display region or a movement amount of the display position, wherein
the control unit controls the display position of the image displayed on the display region by obtaining the display position of the image displayed on the display region or the movement amount of the display position with use of the display control information stored in the storage unit based on the detection position of the marker detected by the detecting unit.

11. The head mounted display device according to claim 10, An input unit that receives an input, wherein
the control unit generates the display control information in which the detection position of the marker detected by the detecting unit is associated with the display position of the image determined based on the input received by the input unit and stores the display control information in the storage unit.

12. The head mounted display device according to claim 11, wherein the control unit changes the display position of the image displayed on the display region with a plurality of steps to achieve different visual recognition distances perceived by the user for the image displayed on the display region, and generates the display control information in which the display position selected based on the input received by the input unit is associated with the detection position of the marker detected by the detecting unit and stores the display control information in the storage unit.

13. A control method for a head mounted display device including a display unit that is mounted on a head of a user, configured to enable an outside scene to be visually recognized through the display unit, and displays an image on a display region overlapping with the outside scene, the control method comprising:
storing in advance display position information including:
distance information indicating a visual recognition distance perceived by the user for the image displayed on the display region; and
a display position of the image displayed on the display region or a movement amount of the display position associated with the distance information;
receiving an input by an input unit; and
controlling, when the distance information is designated by the input received by the input unit, the display position of the image displayed on the display region according to the display position of the image or the movement amount of the display position associated with the designated distance information by the display position information.

14. A control method for a head mounted display device including a display unit that is mounted on a head of a user, configured to enable an outside scene to be visually recognized through the display unit, and display an image on a display region overlapping with the outside scene, the control method comprising:
detecting a marker at least in a range visually recognized through the display unit; and
controlling a display position of the image displayed on the display region based on a detection position of the detected marker.
